(19) United States
(12) Patent Application Publication
(10) Pub. No.: US 2004/0039631 A1
(43) Pub. Date: Feb. 26, 2004

(54) Assessment of an organization's customer relationship management capabilities

(76) Inventors: Brian K. Crockett, Wayzata, MN (US); Sally R. Neal, New York, NY (US); Robert G. Sorensen, Maple Grove, MN (US)

Correspondence Address: STEPHAN J. FILIPEK, Fish & Richardson P.C., 45 Rockefeller Plaza, Suite 2800, New York, NY, 10111, US

(21) Appl. No.: 10/225,665

(22) Filed: Aug. 22, 2002

(51) Int. Cl. G06F 17/60

(52) U.S. Cl. 705/11

(57) ABSTRACT

A software based tool provides an assessment of an organization's customer relationship management capabilities. The tool can, in some cases, assign scores to customer relationship management capabilities in response to receipt of input from a user. An assessment is provided of the customer relationship management capabilities based on the scores assigned to the customer relationship management capabilities.

### BACKGROUND

This disclosure relates to the assessment of an organization's customer relationship management (CRM) capabilities.

Customer relationship management relates to acquiring, developing and retaining satisfied, loyal customers. To achieve profitable growth, it generally is desirable for an organization to increase the number of profitable customers, to increase the profit from existing customers and to extend the duration of the customer's relationship with the organization.

In today's increasingly competitive business environment, a fundamental change has taken place. The emerging global and electronic economy has turned tradition on its head and placed the customer firmly in the control seat, as a result of which power has shifted from the seller to the customer. Customers are more demanding, more aware of their choices, and more in command than ever before. Add the fact that cost-cutting alone will not generate long-term growth, it is clear that CRM is an enterprise-wide imperative.

An organization's capabilities refer to a collection of skills, technologies and cumulative knowledge that may enable an organization to achieved its business and financial goals. In particular, customer relationship management capabilities relate to capabilities that may enable an organization to attract, retain, and develop desired customers and optimize the value of each of these customer relationships. However, many organizations may lack the ability to determine and assess customer relationship management capabilities. As a result, organizations may not experience future profit growth compared to competitors because they may be unable to acquire, develop and retain satisfied, loyal customers compared to their competitors.

### SUMMARY

A software-based tool provides an assessment of an organization's customer relationship management capabilities.

In one aspect, a method includes entering scores into a computer system with respect to an organization's customer relationship management capabilities and causing the computer system to generate an assessment of the organization's customer relationship management capabilities based on the scores.

According to some implementations, the computer system can generate an overall assessment of the organization's customer relationship management capabilities using a weighted score of each of the capabilities. The computer system also can generate an assessment of each of the organization's customer relationship management capabilities using a weighted score of each of the capabilities.

The customer relationship management capabilities may include a first category that identifies customer insight, a second category that identifies customer interaction, a third category that identifies customer offerings, a fourth category that identifies high performing organization, and a fifth category that identifies enterprise integration. The computer system also can generate the assessment based on relative weights assigned to each capability, wherein each of the weights may be different. Each score may represent a perception of the organization's relative performance with respect to a particular capability. The computer system may display a summary of the assessment that includes a radar diagram. The assessment may be used as a basis for assessing the current state of an organization's approach to customer relationship management. The computer system may provide one or more score entry forms listing the organization's customer relationship management capabilities, wherein the assessment may be based on capabilities selected from the list.

The detailed description also discloses an apparatus that includes a database to store a framework for customer relationship management capabilities. A processor is coupled to the database. Memory includes instructions that, when applied to the processor, cause the processor to provide a score entry form based on the framework, assign scores to customer relationship management capabilities in response to receipt of input from a user, and provide an assessment of the customer relationship management capabilities based on the scores assigned to the customer relationship management capabilities.

The techniques described in greater detail below can help an organization become more competitive in today's business environment by providing an assessment of the organization's CRM capabilities compared to a potential measure. The assessment provides both a detailed and high-level “snapshot” of the maturity of the organization's CRM capabilities. The assessment may help the organization identify its strengths and weaknesses among CRM capabilities which may be important to attract, retain, and develop desired customers and optimize the value of each of these customer relationships.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a system that includes a tool for assessing an organization's CRM capabilities.

FIGS. 2A through 2E illustrate an example of a weighted CRM capabilities framework for assessing an organization's CRM capabilities.

FIG. 3 is a chart showing an example of a scoring technique for assessing an organization's CRM capabilities.

FIG. 4 is a portion of a form for entering scores for assessing an organization's CRM capabilities.

FIG. 5 is a flow chart of a method of assessing an organization's CRM capabilities.

FIG. 6 is a table illustrating an example of an assessment of an organization's CRM capabilities.

FIGS. 7A and 7B are examples of bar charts showing an assessment of an organization's CRM capabilities.

FIG. 8 illustrates an example of an overall assessment of an organization's CRM capabilities.

FIG. 9 illustrates an example of a radar diagrams showing an overall assessment of an organization's CRM capabilities.

### DETAILED DESCRIPTION

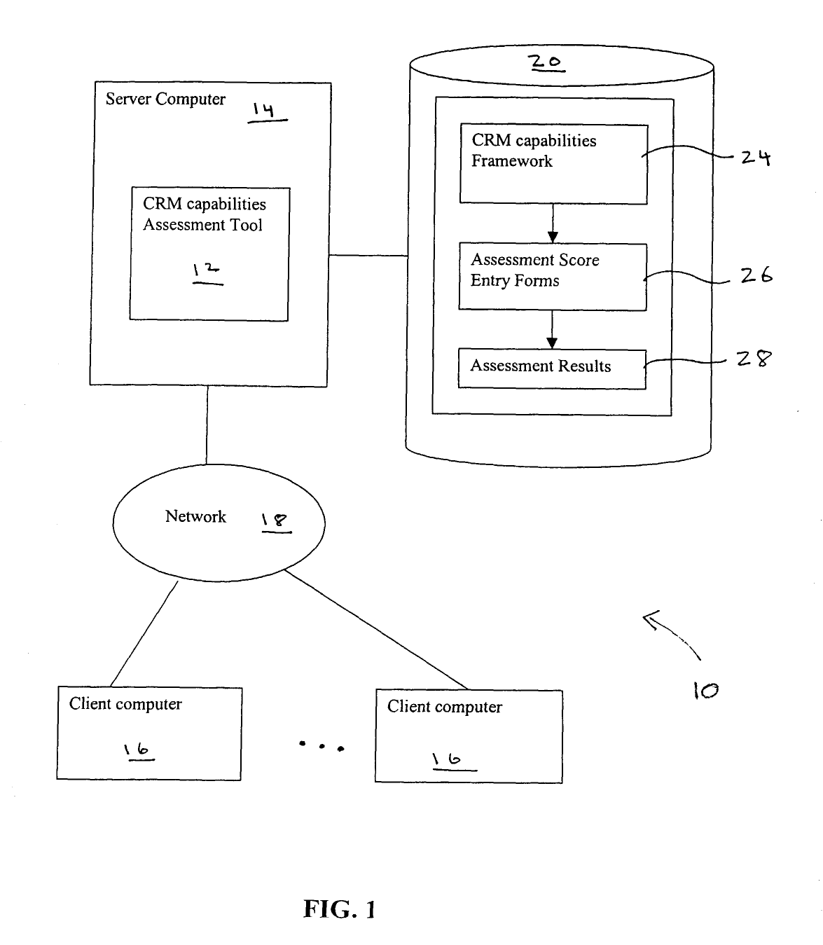

A shown in FIG. 1, a system 10 includes a CRM capabilities assessment tool 12 hosted, for example, on a server computer 14 that can be accessed from one or more client computers such as personal computers 16 over the Internet or other computer network 18. A database 20 is associated with the assessment tool 12 and stores assessment data that includes a CRM capabilities framework 24 for generating assessment score entry forms 26 and assessment results 28. In some implementations, the assessed organization may be given access to the results through an Extranet or through on-line subscription rights.

In general, the assessment tool 12 can provide score entry forms 26 based on the CRM capabilities framework 24, assign a score to each of the capabilities based on the scores entered on the forms, and provide assessment results 28 of the organizations CRM capabilities compared to capabilities in the framework. The framework includes capabilities that are grouped into components, each of which is organized into categories. The capabilities may be associated with different weights based on the relative importance of the capability, component, or category. The score entry forms 26 may be presented using display formats such as Web pages or spreadsheets. The assessment results 28 may be generated by importing the scores from the entry forms 26 and using a standalone computer program, a spreadsheet program or other calculation means to produce the results. In one example, the tool 12 can produce an electronic (or paper-based) questionnaire based on the score entry forms 26 and present the questionnaire to the user on a display of a personal computer over the network. The tool 12 can then prompt the user to answer questions on the questionnaire which are subsequently used by the tool to score the capabilities.

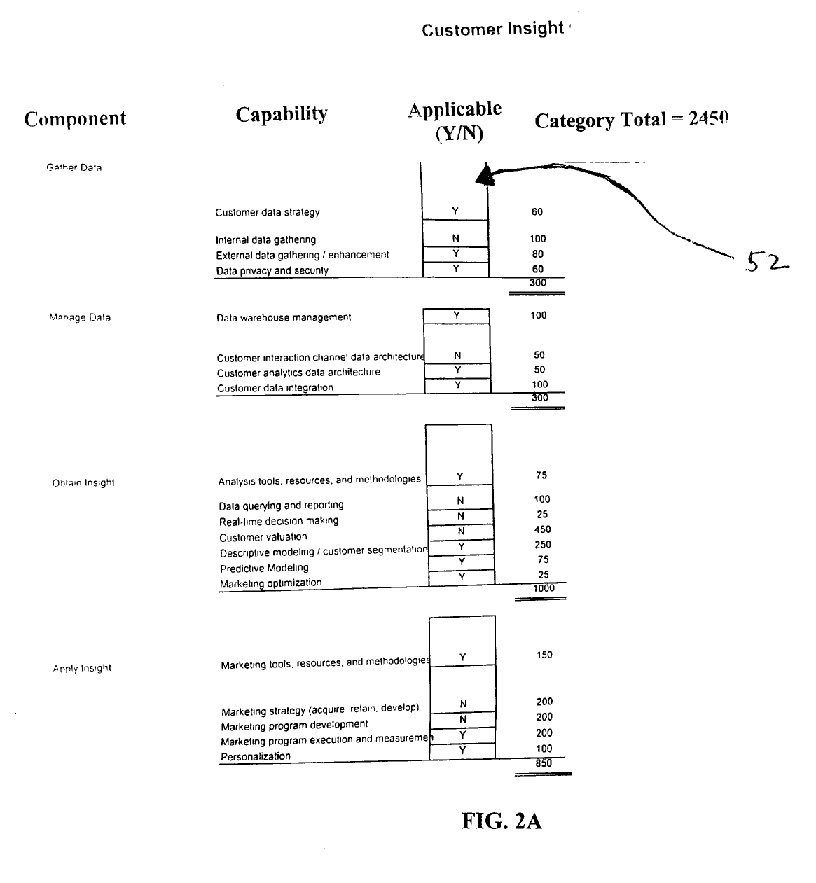

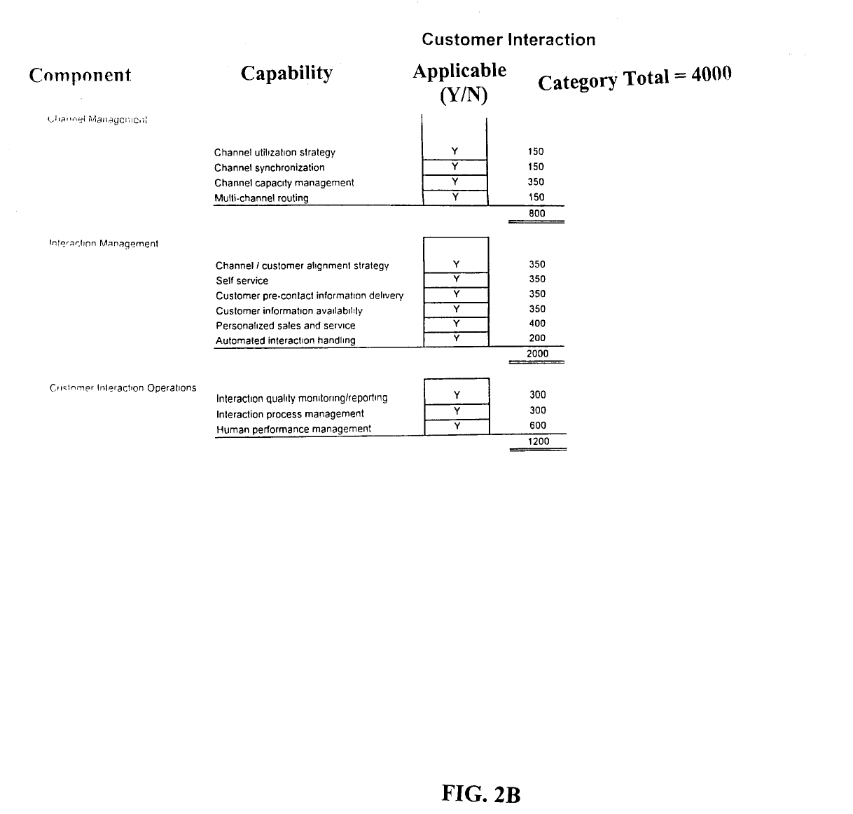

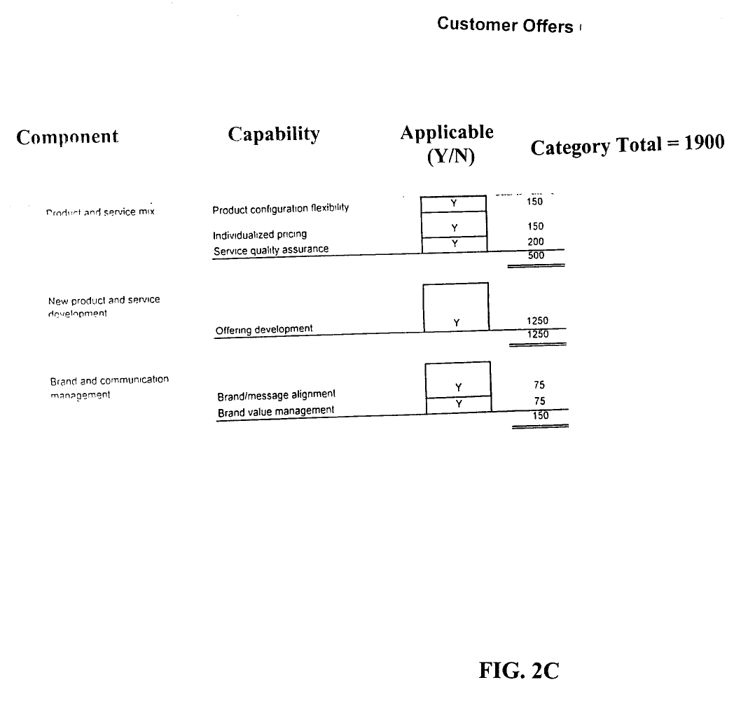

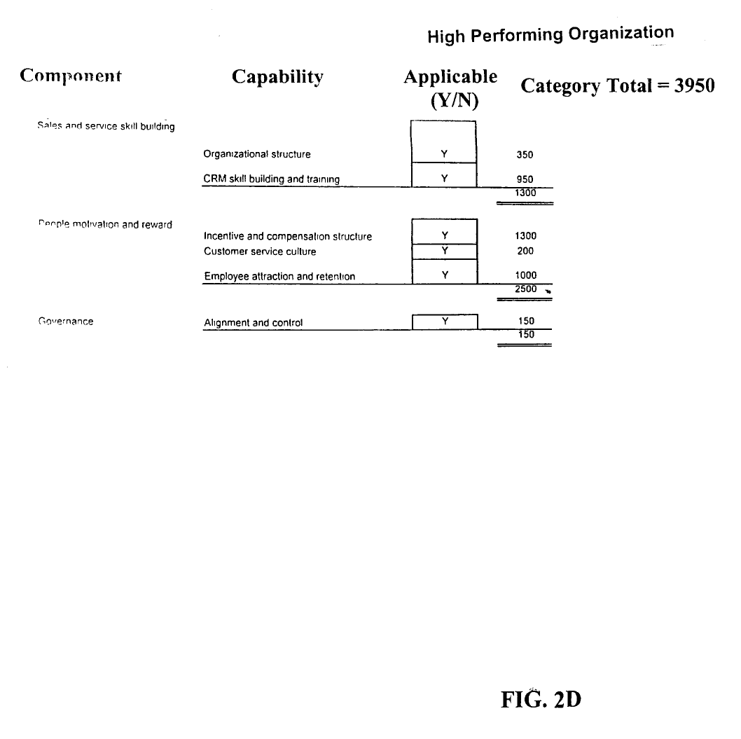

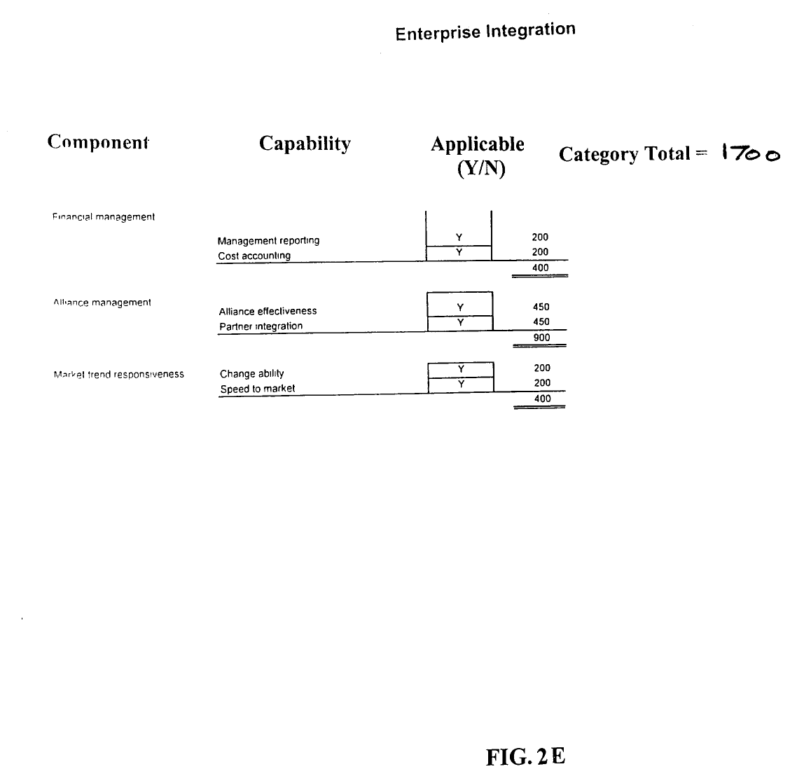

In one particular implementation, as shown in FIGS. 2A through 2E, an organization's CRM capabilities can be assessed against a capability assessment framework that groups capabilities into the following categories: Customer Insight (FIG. 2A), Customer Interaction (FIG. 2B), Customer Offers (FIG. 2C), High Performing Organizations (FIG. 2D) and Enterprise Integration (FIG. 2E). Each of the CRM capability categories includes one or more components, each of which include individual CRM capabilities.

The Customer Insight category (FIG. 2A) includes capabilities that relate to an organization's ability to capture relevant customer information across all customer contact points, which can be used to build a unique, fact-based understanding of the customer's needs, historical buying behaviors, and potential value. The Customer Interaction category (FIG. 2B) includes capabilities that relate to how effective an organization is in enabling customers to interact seamlessly across all contact points, whenever, wherever, and however they choose.

The Customer Offers category (FIG. 2C) includes capabilities that relate to an organization's ability to configure products and services into differentiated solutions that meet customer's needs and intentions better than competitive alternatives. The High Performing Organization category (FIG. 2D) includes capabilities that relate to an organization's ability to align the organization to create an environment that attracts, develops and retains the best customer skills and experience across the enterprise. The Enterprise Integration category (FIG. 2E) includes capabilities that relate to an organizations ability to align customer-facing functions with other functions involved in the satisfaction of customer demands, both internally and externally to the organization. The foregoing categories and capabilities are intended as examples.

In this example, the capabilities may represent industry practices that may include the most relevant skills, technologies and cumulative knowledge that may allow an organization to attract, retain, and develop desired customers and optimize the value of each of these customer relationships. The capabilities can be derived from sources such as industry studies, experience of an organization, and research on brand value, CRM and marketing technology and processes, alliances and partnerships, organized structures, and new product development and launches. The capabilities represent information that may be used by management, investors, analysts and other to gain an understanding of the organization's performance in the context of CRM capabilities. The capabilities also represent processes, technology, organizational factors, and alliances/partnerships that are sued to support an organization's CRM objectives.

In the example illustrated by FIG. 2A, the Customer Insight category includes the following capability components: Gather Data, Manage Data, Obtain Insight and Apply Insight. The Gather Data component, in this example, relates to capabilities associated with gathering data from internal/external sources. The Manage Data component relates to capabilities associated with managing the gathered data. The Obtain Insight component relates to capabilities associated with obtaining insight from the gathered data including using, for example, predictive modeling techniques. The Apply Insight component relates to capabilities associated with applying insight that may have been obtained using, for example, marketing tools, marketing strategy and marketing program development, execution and measurement.

Each of the capabilities in the framework of FIGS. 2A through 2E includes a flag 52 which can be set to indicate whether the particular capability is applicable to the organization. For example, FIG. 2A shows the Customer Insight category with a flag 52 which can be set to “Y” to indicate that the particular capability is applicable, and set to “N” if it is not. Thus, setting the flag 52 to “Y” includes the capability in the overall assessment, whereas setting the flag 52 to “N” removes the capability from the assessment.

Each of the capabilities in the framework shown in FIGS. 2A through 2E is associated with a weight. For example, FIG. 2A shows that the Customer Insight category has been assigned a maximum total weight of 2450. The total weight of 2450 is distributed among the components and the capabilities within each component. For example, the Gather Data component has been assigned a maximum weight of 300, the Manage Data a weight of 300, the Obtain Insight a weight of 1000 and the Apply Insight a weight of 850. In the example, the Gather Data component has a weight of 300 which is distributed among the customer data strategy capability with a weight of 60, the internal Data gathering capability with a weight of 100, the external data gathering/enhancement capability with a weight of 80 and the data privacy and security capability with a weight of 60.

The value of the weights assigned to each of the capabilities represent the relative importance of the capabilities. For example, in the Gather Data component of the Customer Insight category, the Internal data gathering capability (weight of 100) may have a greater impact on the overall assessment than the Customer data strategy capability (weight of 60). The weights can be based on a combination of the following factors: user and/or academic research, user experience, and common sense and logic. If there is insufficient research or defensible, credible experience to make an educated judgment as to which component or capability is the critical value driver, the weights can be distributed, for example, equally among the components and capabilities. Although not shown, each capability also may be provided with an explanation column which can supply a narrative rationale behind the allocation of the different weights among the capabilities.

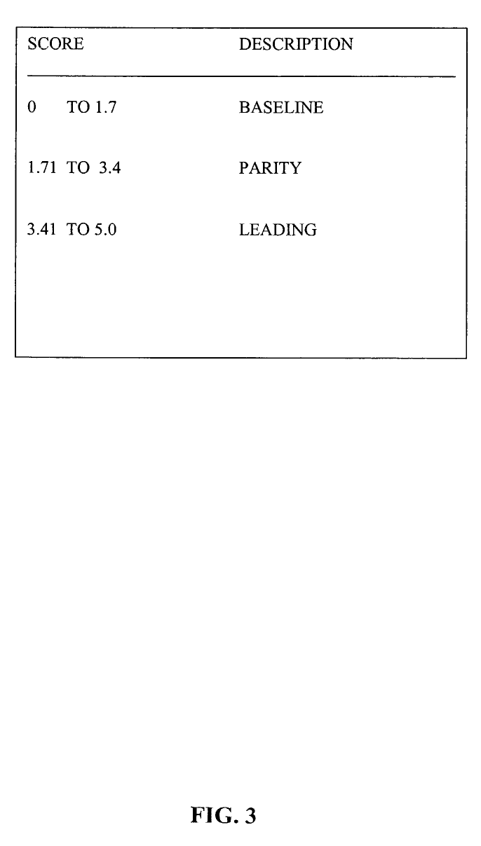

FIG. 3 is chart showing an example of a scoring technique for assessing an organization's CRM capabilities. In this example, the chart includes a first column (Score Value) specifying one of three possible numerical scores to assign to each capability. A second column (Description) provides a text description of the corresponding score. For example, a scorer can select a score based on the level or maturity of a CRM capability practiced by the organization. A baseline practice may suggest that the organization retains practices that might not be considered leading edge. A parity practice may suggest that the organization retains practices that might be considered standard or routine and comparable to other companies' CRM practices. In contrast, a leading practice may suggest that the organization may be executing forward thinking, progressive practices which might be considered to provide a competitive edge.

As shown in the chart, the scorer can assign a minimum score(0 to 1.7) to the CRM capability if it considers the practice of the capability by the organization to be baseline. In contrast, the scorer can assign a maximum score (3.41 to 5.0) to the CRM capability if it considers the practice of the capability by the organization to be leading edge. An organization having a parity practice can be assigned an intermediate score (1.71 to 3.4). This scoring technique is meant to illustrate one example of a scoring technique. Thus, the score can be based on the perception of the organization's relative performance with respect to a particular capability. Other techniques may be used such as, for example, a rating system which rates each capability on a numerical score in the range from 0 to 10, a rating system based on percentage, or other rating system.

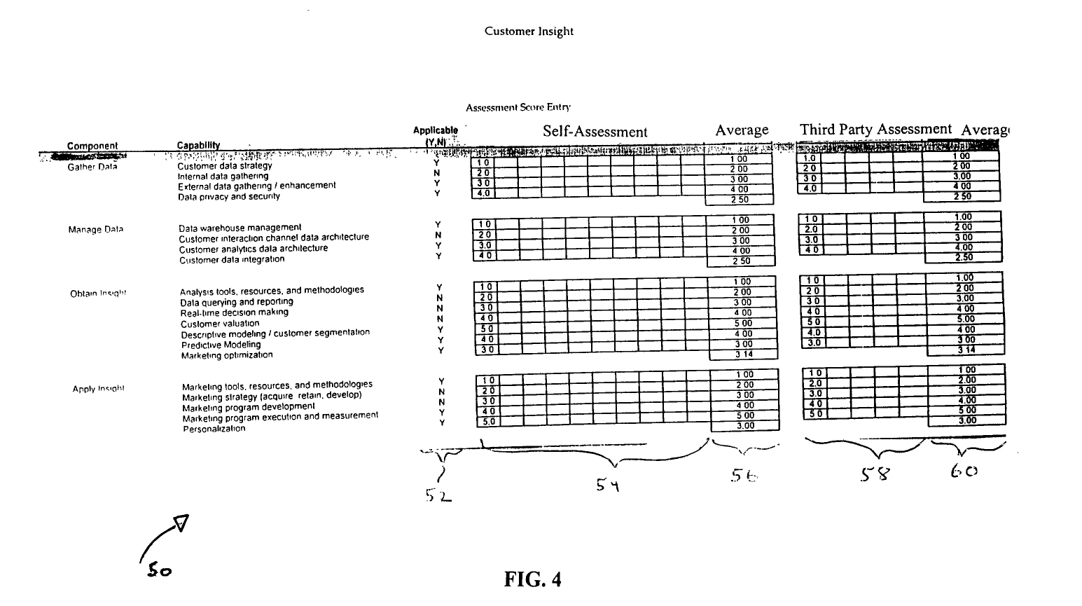

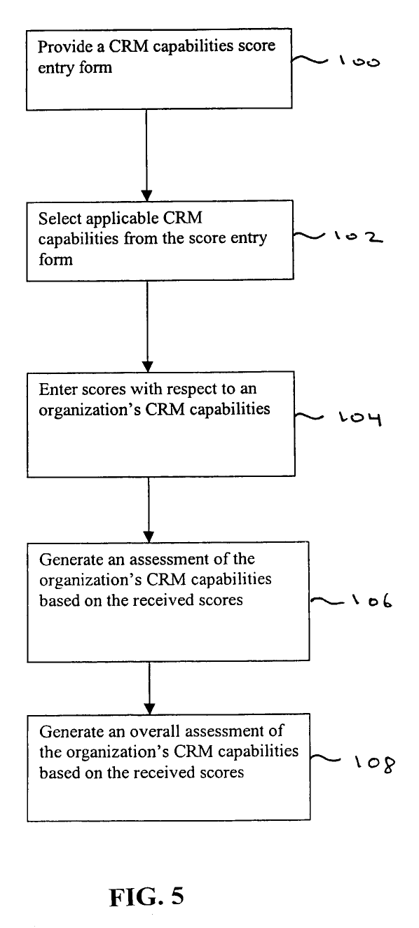

As indicated by FIG. 5, the assessment tool 12 (FIG. 1) provides (block 100) a CRM capabilities score entry form 50 for each capability category. For example, FIG. 4 shows a score entry form 50 for entering scores for assessing an organization's CRM capabilities. In this example, the score entry form 50 is for the Customer Insight category.

The organization or scorer selects (block 102) the applicable CRM capabilities from the score entry form 50 by setting the flag 52 to “Y” of the relevant capability. (The flag 52 is shown in FIG. 2 and is automatically carried over in the spreadsheet) As mentioned above, each capability is applicable if the flag 52 is set to “Y”; otherwise the particular capability is not included in the assessment. In this example, the capability customer data strategy has the flag 52 set to a “Y”. In contrast, the capability internal data gathering has the flag 52 set to “N” and, thus, the score is not considered in the assessment.

The scores can enter scores (block 104) with respect to an organization's CRM capabilities. The score entry form 50 provides a self-assessment area 54 containing 10 blocks in which one or more individuals associated with the organization being assessed can enter a score to rate each capability. A corresponding area 56 provides a block for an average of the scores entered in the self-assessment area 54 for each capability. In this example, the customer data strategy capability has been rated with a value “1” as shown in the first block and the has an average value of “1” as shown in area 56. An average also is calculated for the capabilities at the component level as well as at the category level. In this example, the average for the component Gather Data has a value of 2.5. The average scores can be automatically calculated.

The score entry form 50 also provides a third-party assessment area 58 which allows a third party to assess an organization in a manner similar to the manner used by the organization in the self-assessment area 54 described above. The third-party assessment area 58 contains 5 blocks for the third-party to enter scores for each capability that is applicable. A corresponding area 60 provides an average of the scores entered in the third-party assessment area 58. Having a self-assessment score and a third-party assessment score may allow the organization to compare its own assessment with the third-party assessment. Once the scores have been entered, an average is calculated automatically displayed by the tool 12 and displayed in the corresponding areas 56, 60.

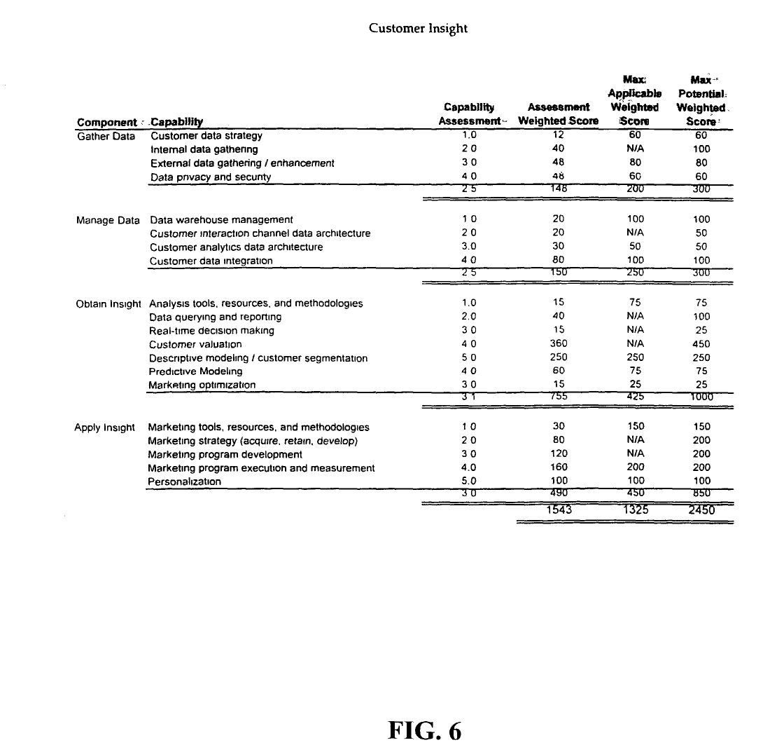

After the scores for each capability have been entered, the assessment tool generates (block 106) an assessment of the organizations CRM capabilities based on the entered scores. FIG. 6 illustrates an example of a table showing an assessment of an organization's CRM capabilities for the Customer Insight category. The assessment includes a Capability Assessment, an Assessment Weighted Score, a Maximum Applicable Weighted Score, and a Maximum Potential Weighted Score. The Capability Assessment represents the average score for the particular CRM capability based on scores entered by a third party. Although not shown, the tool can calculate and display a Capability Self-Assessment which represents the average score for the capability based on the scored entered by the organization. The Assessment Weighted Score may be calculated by multiplying the Maximum Potential Weighted Score by the ratio of the Capability Assessment score (0 to 5) over the maximum possible Capability Assessment score (5). The Maximum Applicable Weighted Score indicates whether the score is applicable based on the setting of the flag 52.

For example, for the Customer data strategy capability in the Gather Data component, the Capability Assessment has been assigned a score of “1” and the Assessment Weighted Score is “12”. The Assessment Weighted score is calculated by multiplying the Maximum Potential Weighted Score (“60”) by the ratio of the Capability Assessment score over the maximum possible Capability Assessment score. In this example, the ratio would be 1/5 or 20%. On the other hand, the capability “Internal data gathering” is not applicable (N/A) to the calculations because the corresponding flag 52 has been set to “N” (see FIG. 4). Similar calculations can be performed to generate and display average values at the CRM component level as well as CRM category level.

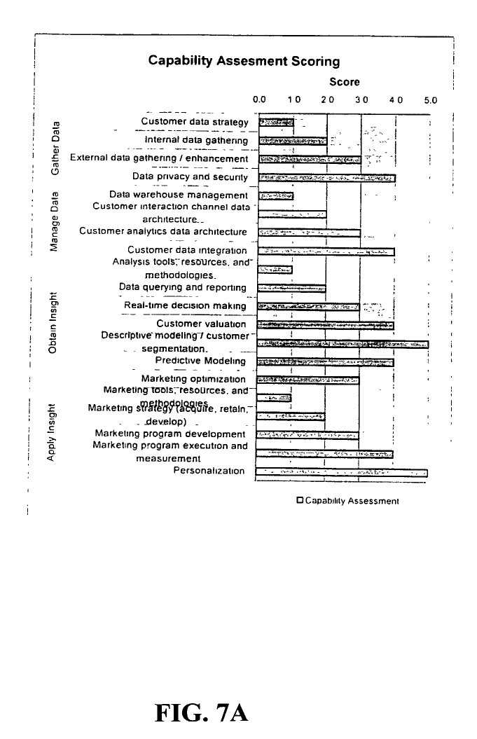

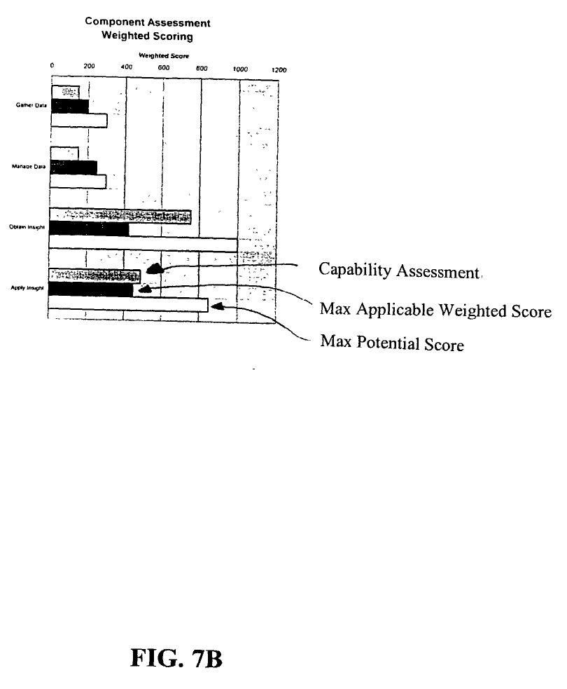

FIGS. 7A through 7B are examples of bar charts showing an organization's CRM capabilities based on the assessment of the Customer Insight capability category in FIG. 6. These bar charts graphically depict where the organization is positioned in the spectrum of CRM capability. FIG. 7A is a Capability Assessment Scoring bar chart which graphically depicts the un-weighted average assessment score (0 to 5) for each CRM capability in the Customer Insight category. For example, the Internal data gathering category (score of 2) has a higher rating than the Customer data strategy category (score of 1). This suggests that these capabilities may be lagging in the organization and, thus, may need improvement.

FIG. 7B is a Capability Assessment Weighted Scoring bar chart which graphically depicts the weighted average assessment score for each capability component of the Customer Insight category. This assessment takes into account the applicability of individual CRM capabilities. In this bar chart, three separate scores are displayed for each capability component: A Capability Assessment, A Maximum Applicable Weighted Score, and a Maximum Potential Score, which correspond to the scores in FIG. 6. The bar chart of FIG. 7B allows the organization to compare how the CRM capabilities compare at the CRM component level.

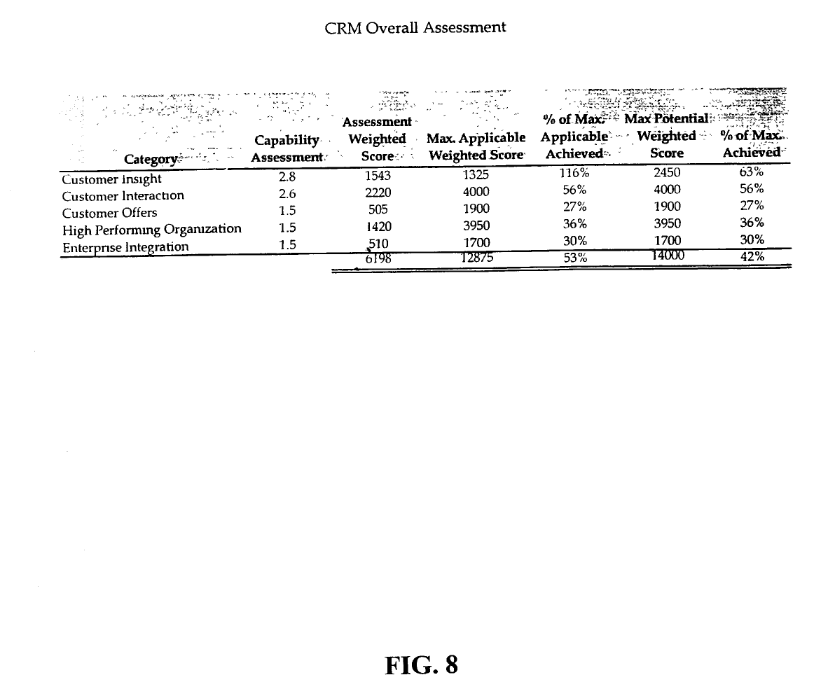

The assessment tool 12 generates (block 108) an overall assessment of the organization's CRM capabilities based on assessment of the capabilities at the category and component levels. For example, FIG. 8 illustrates an example of an assessment of an organization's overall CRM capabilities. This assessment shows the following measurements for each of CRM capability categories: (1)Capability Assessment, (2)Assessment Weighted Score, (3)Maximum Applicable Weighted Score, (4)percent of Maximum Applicable Achieved, (5)Maximum Potential Weighted Score, and (6)percent of Maximum Achieved. The “percent of Maximum Applicable Achieved” measurement is calculated by dividing the Assessment Weighted Score by the Maximum Applicable Weighted Score. Likewise, the “percent of Maximum Achieved” is calculated by dividing the Assessment Weighted Score by the Maximum Potential Weighted Score. These measurements may allow the organization to evaluate each CRM capability category against a maximum value. For example, the assessment shows that the Customer Insight category has achieved 63% of the maximum value compared to the Enterprise Integration category which has only achieved 30% of the maximum value.

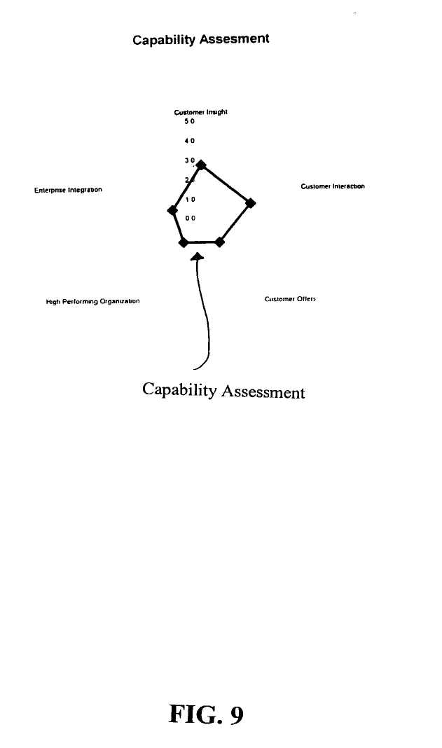

FIG. 9 is a radar or spider diagram of an organization's overall CRM capabilities. The radar diagram graphically depicts where the organization is positioned on the spectrum of CRM capability maturity. Radar diagrams may provide the organization an opportunity to evaluate how close it is to achieving maximum CRM capability maturity. The radar diagram depicts the un-weighted average assessment score (0 to 5) for each CRM capability category of FIG. 9. The tool 12 also can generate other radar diagrams showing other measurements from FIG. 9. For example, the tool 12 can generate a Weighted Score Assessment radar diagram which depicts the weighted average assessment score for each CRM capability category.

Various features of the system can be implemented in hardware, software, or a combination of hardware and software. For example, some features of the system can be implemented in computer programs executing on programmable computers. Each program can be implemented in a high level procedural or object-oriented programming language to communicate with a computer system. Furthermore, each such computer program can be stored on a storage medium such as read-only-memory (ROM) readable by a general or special purpose programmable computer or processor, for configuring and operating the computer to perform the functions described above.

In some implementations, instead of having the CRM capabilities assessment tool 20 implemented on the server computer 14, the tool can be implemented on a standalone computer such as a PC. Other embodiments are within the scope of the following claims.

What is claimed is:

1. A method comprising:
entering scores into a computer system with respect to an organization's customer relationship management capabilities; and
causing the computer system to generate an assessment of the organization's customer relationship management capabilities based on the scores.

2. The method of claim 1 including causing the computer system to generate an overall assessment of the organization's customer relationship management capabilities using a weighted score of each of the capabilities.

3. The method of claim 1 including causing the computer system to generate an assessment of each of the organization's customer relationship management capabilities using a weighted score of each of the capabilities.

4. The method of claim 1 wherein the customer relationship management capabilities includes a category that identifies customer insight.

5. The method of claim 1 wherein the customer relationship management capabilities includes a category that identifies customer interaction.

6. The method of claim 1 wherein the customer relationship management capabilities includes a category that identifies customer offers.

7. The method of claim 1 wherein the customer relationship management capabilities includes a category that identifies high performing organization.

8. The method of claim 1 wherein the customer relationship management capabilities includes a category that identifies enterprise integration.

9. The method of claim 1 including causing the computer system to generate the assessment based on relative weights assigned to each capability.

10. The method of claim 9 wherein each of the weights is different.

11. The method of claim 1 wherein each score represents a perception of the organization's relative performance with
respect to a particular capability.

12. The method of claim 1 including causing the computer system to display a summary of the assessment.

13. The method of claim 12 wherein the summary includes a radar diagram.

14. The method of claim 1 including using the assessment as a basis for assessing the current state of an organization's approach to customer relationship management.

15. The method of claim 1 including: causing the computer system to provide one or more score entry forms listing the possible customer relationship management capabilities; and
selecting customer management capabilities relevant to the organization, wherein the assessment is based on the selected capabilities.

16. An apparatus comprising:
a database to store a framework for customer relationship management capabilities;
a processor coupled to the database; and
a memory storing instructions that, when applied to the processor, cause the processor to:
provide a score entry form based on the framework,
assign scores to customer relationship management capabilities of an organization in response to receipt of input from a user, and
provide an assessment of the customer relationship management capabilities of the organization based on the scores assigned to the customer relationship management capabilities.

17. The apparatus of claim 16 wherein the memory includes instructions that, when applied to the processor, cause the processor to generate an overall assessment of the organization's customer relationship management capabilities using a weighted score of each of the capabilities.

18. The apparatus of claim 16 wherein the memory includes instructions that, when applied to the processor, cause the processor to generate an assessment of each of the organization's customer relationship management capabilities using a weighted score of each of the capabilities.

19. The apparatus of claim 16 wherein the customer relationship management capabilities includes a category that identifies customer insight.

20. The apparatus of claim 16 wherein the customer relationship management capabilities includes a category that identifies customer interaction.

21. The apparatus of claim 16 wherein the customer relationship management capabilities includes a category that identifies customer offerings.

22. The apparatus of claim 16 wherein the customer relationship management capabilities includes a category that identifies high performing organization.

23. The apparatus of claim 16 wherein the customer relationship management capabilities includes a category that identifies enterprise integration.

24. The apparatus of claim 16 wherein the memory includes instructions that, when applied to the processor, cause the computer system to generate the assessment based on relative weights assigned to each capability.

25. The apparatus of claim 24 wherein each of the weights is different.

26. The apparatus of claim 16 wherein each score represents a perception of the organization's relative performance with respect to a particular capability.

27. The apparatus of claim 16 wherein the memory includes instructions that, when applied to the processor, cause the processor to display a summary of the assessment.

28. The apparatus of claim 16 wherein the memory includes instructions that, when applied to the processor, cause the processor to provide one or more score entry forms listing the organization's customer relationship management capabilities, wherein the assessment is based on capabilities selected from the list.

29. An article including a computer-readable medium storing computer-executable instructions that, when applied to the computer system, cause the computer system to:
assign scores to customer relationship management capabilities of an organization in response to receipt of input from a user; and
provide an assessment of the customer relationship management capabilities based on the scores assigned to the customer relationship management capabilities.

30. The article of claim 29 including instructions for causing the computer system to generate an overall assessment of the organization's customer relationship management capabilities using a weighted score of each of the capabilities.

31. The article of claim 29 including instructions for causing the computer system to generate an assessment of each of the organization's customer relationship management capabilities using a weighted score of each of the capabilities.

32. The article of claim 29 including instructions for causing the computer system to generate the assessment based on relative weights assigned to each capability.

33. The article of claim 29 including instructions for causing the computer system to display a summary of the assessment, wherein the summary includes a radar diagram.

34. The article of claim 29 including instructions for causing the computer system to cause the processor to provide one or more score entry forms listing the organization's customer relationship management capabilities, wherein the assessment is based on capabilities selected from the list.
